(19) United States
(12) Patent Application Publication
(10) Pub. No.: US 2003/0154154 A1
(43) Pub. Date: Aug. 14, 2003

(54) Trading partner conversation management method and system

(76) Inventors: Mehmet Sayal, Sunnyvale, CA (US); Fabio Casati, Palo Alto, CA (US); Ming-Chien Shan, Saratoga, CA (US)

Correspondence Address: HEWLETT-PACKARD COMPANY, Intellectual Property Administration, P.O. Box 272400, Fort Collins, CO, 80527-2400, US

(21) Appl. No.: 10/066,238

(22) Filed: Jan. 30, 2002

(51) Int. Cl. G06F 17/60

(52) U.S. Cl. 705/37

(57) ABSTRACT

A trading partner conversation management method and system. A trading partner conversation manager (TPCM) manages conversations between a first enterprise and a second enterprise. The TPCM polls a workflow server and determines whether a service type is a send message or a receive message. When the service type is a send message, the TPCM retrieves a service definition, retrieves an XML template, prepares an XML response, and sends the XML message. When the service type is a receive message, the TPCM retrieves a service name and XQL queries, parses the request and extracts data, starts a service and passes the data to the service, obtains service results, retrieves an XML template, prepares an XML response, sends the XML response, and returns control to the workflow server.

### FIELD OF THE INVENTION

The present invention relates generally to electronic business technology, and more particularly, to a trading partner conversation management method and system.

### BACKGROUND OF THE INVENTION

Workflow management is a rapidly evolving technology that many businesses in a variety of industries utilize to handle business processes. A business process, as defined by the Workflow standard—Terminology & glossary, Technical Report WFMC-TC-1011, Workflow Management Coalition, June 1996. Versions 2.0, is simply a set of one or more linked activities that collectively realize a business objective or a policy goal, typically within the context of an organizational structure defining functional roles and relationships. A workflow is defined as the automation of a business process, in whole or in part, during which documents, information, or activities are passed from one participant to another, according to a set of predefined rules.

Business processes are often automated using Workflow Management Systems (WfMSs). WfMSs are tools that enable model-driven design, analysis, and simulation of business processes, which can be designed from scratch or from templates that support rapid application development. WfMSs also provide features for monitoring the execution of business processes and for automatically reacting to exceptional situations. The integration of WfMSs with Enterprise Application Integration (EAI) tools further increases the effectiveness of these systems, and enables them to handle the two crucial aspects of process automation: end-to-end process flow management and interaction with the (heterogeneous) invoked applications. Finally, enhancement of WfMSs with support for B2B interaction standards will result in complete automation of business operations both within and across organizational boundaries.

Organizations need to integrate their processes in order to efficiently trade goods and services electronically and perform e-business transactions. Several industry standards, such as RosettaNet and the Common Business Library (CBL), are being developed in order to allow organizations to interoperate by defining common ontology, syntax for message exchanges, and flow of interactions among the business processes across organization boundaries.

In order to interact with a trade partner, an organization must not only be able to send and receive messages and carry out conversations according to a specific standard, but also be capable of coordinating the internal business processes with the external interactions. In addition, since B2B standards are constantly evolving as a result of the changes in the technology and needs of organizations, it is necessary for the business partners to quickly and easily adapt to the changes in the standards. The implementation of new standards and their integration with the internal business processes often require a lot of manual effort and take many months to complete. Moreover, the users (e.g., the designers of internal business processes) are usually required to deal with the details of B2B conversations, message formats, data mapping, etc. The process designer's time is better used in concentrating on designing the business logic of their organizations' business processes rather than worrying about the details of B2B interaction standards.

There exist many B2B interaction standards already in use or under development. Enterprises have to support many different standards in order to be able to carry on trade partnerships with multiple partners, because each partner might have adopted a different standard. In summary, even after B2B interaction standards are defined, there exist many important challenges that need to be addressed in order to build and operate on-line trade partnerships quickly and easily. Those challenges include how to minimize the manual effort in integration of existing and new internal business processes with external B2B interaction standards, how to adapt to the changes in B2B interaction standards, and how to hide B2B interaction details from the users, and how to support multiple B2B interaction standards in conversations with the trade partners.

Organizations may often need to carry on a conversation (i.e., exchange several messages with one or more business partners) in order to accomplish B2B interactions. Unfortunately, most B2B standards do not describe the complete conversational logic between trade partners. Some standards, such as EDI, only describe how individual transactions should be carried on. Some others, such as OBI and cXML, describe the contents of individual message exchanges. RosettaNet and CBL are two recently initiated B2B interaction standards that aim at describing the complete conversational logic between trade partners. Although those standards describe the contents of individual messages in a structured format, using either XML DTDs or schema language, the overall conversational logic is described as a combination of flat text and graphical representation (UML diagrams). In other words, those conversational logic descriptions aim the humans as the target audience. Process designers are supposed to read, understand, and implement the conversational logic themselves. Thus, intensive manual effort is required to implement those standards.

FIG. 9 illustrates a prior art partner interface process (PIP) that defines an interaction standard for a request for quote. A PIP definition includes a UML graph and text that describes the process. One problem with these high-level descriptions is that the UML graphs and unstructured textual representations are very difficult to interpret and use for automatically implementing the PIP.

Typically, only humans can interpret and use the descriptions. However, the standards may be interpreted differently that may lead to compatibility issues between business parties. In fact intensive manual efforts are required by process designers to integrate an external interaction standard with a particular workflow management system. This manual development is time consuming and difficult since there is no mechanism in the prior art to automatically generate B2B interaction standard compliant business processes or to adapt existing business processes to become B2B interaction capable.

Another problem that a designer of business processes faces is that there are many competing business-to-business interaction standards. Business partners, suppliers, vendors, and clients may implement different interaction standards. For example, a first partner may utilize a RosettaNet B2B interaction standard, whereas a second partner may utilize a CBL B2B interaction standard. In order to enable electronic commerce with both the first partner and the second partner, the designer is required to manually integrate its internal business processes with both the RosettaNet business-to-business interaction standard and the CBL B2B interaction standard.

This problem is further exacerbated by the constant evolving nature of these external B2B interaction standards. For example, a designer can work many months to integrate the internal processes with a first version of RosettaNet B2B interaction standard only to find that other new partners are now using another, more current, RosettaNet B2B interaction standard. The designer is then forced to integrate the internal processes to the new version of the RosettaNet B2B interaction standard. As can be appreciated, the designers can easily become bogged down with the detail of integrating the internal business processes with many different interaction standards and/or different versions of the same interaction standard.

There exist commercially available products that purport to support RosettaNet and other B2B interaction standards. Unfortunately, most of those products only provide simple tools for sending and receiving XML messages. A few of these products attempt to address the problem of integrating B2B interaction standards with internal workflows.

WebMethods includes a component that enforces the XML message exchange specifications of PIPs, such as preparing, submitting, receiving, and parsing XML documents, and waiting for acknowledgment and response messages. Unfortunately, the actual implementation of the conversational logic of PIPs still requires considerable manual effort.

BlueStone's Total-e-B2B product provides tools to develop, deploy, and manage B2B transactions. This product supports standards, such as XML, EDI, J2EE, etc. Unfortunately, the product does not support any standard that defines B2B conversations, such as CBL and RosettaNet.

Vitria's BusinessWare product has a RosettaNet centric version that purportedly supports currently published PIPs. The product provides basic functionality that is required to carry out B2B interactions based on RosettaNet PIP definitions. The product also performs data mapping from DUNS, UNSPSC, and GTIN standards, which are data standards accepted by RossettaNet. Unfortunately, this product does not provide integration with any internal workflow management systems.

BEA's WebLogic Collaborate Enabler for RosettaNet provides a “Process Integrator” that manages the exchange of XML messages with trade partners. Moreover, WebLogic provides templates for currently published RosettaNet PIPs. It appears that new templates are created manually from PIP definitions by WebLogic and provided to the customers in a template library.

While these approaches offer limited support for interactions among workflows executed in different organizations, these approaches do not provide an efficient approach for addressing the problem of integrating B2B interaction standards with internal processes. In this regard, it is desirable for there to be a mechanism that enables fast, template-driven generation of processes and services that can interact according to B2B interaction standards.

In this regard, it is desirable for there to be a mechanism that facilitates inter-enterprise communication between workflows. As can be appreciated, the need to have workflows interact and cooperate across different organizations pose numerous challenges to prior art workflow systems.

Based on the foregoing, there remains a need for a method and system for a mechanism for integrating internal workflows with external message exchange standards and that overcomes the disadvantages set forth previously.

### SUMMARY OF THE INVENTION

According to one embodiment of the present invention, a trading partner conversation management method and system are provided.

One aspect of the present invention is the provision of a mechanism that facilitates inter-enterprise communication between workflows.

Another aspect of the present invention is to reduce the amount of manual effort required for integrating new and existing internal business processes with external business-to-business interaction standards.

According to another embodiment, a trading partner conversation management method and system are described. A trading partner conversation manager (TPCM) manages conversations between a first enterprise and a second enterprise. The TPCM polls a workflow server and determines whether a service type is a send message or a receive message. When the service type is a send message, the TPCM retrieves a service definition, retrieves an XML template, prepares an XML response, and sends the XML message. When the service type is a receive message, the TPCM retrieves a service name and XQL queries, parses the request and extracts data, starts a service and passes the data to the service, obtains service results, retrieves an XML template, prepares an XML response, sends the XML response, and returns control to the workflow server.

Other features and advantages of the present invention will be apparent from the detailed description that follows.

### BRIEF DESCRIPTION OF THE DRAWINGS

The present invention is illustrated by way of example, and not by way of limitation, in the figures of the accompanying drawings and in which like reference numerals refer to similar elements.

FIG. 1 is a block diagram illustrating a system for supporting the integration of workflow management systems with business-to-business interaction standards according to one embodiment of the present invention.

FIG. 2 is a flowchart illustrating the processing steps performed by the TPCM of FIG. 1.

FIG. 3 is a block diagram illustrating in greater detail the TPCM of the FIG. 1.

FIG. 4 illustrates how the TPCM of the present invention facilitates the interaction between two trading partners.

FIG. 5 illustrates the processing steps performed by the TPCM of FIG. 1 when submitting B2B messages according to one embodiment of the present invention.

FIG. 6 illustrates the processing steps performed by the TPCM of FIG. 1 upon receiving a reply according to one embodiment of the present invention.

### DETAILED DESCRIPTION

A method and system for managing conversations between trading partners are described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

System 100

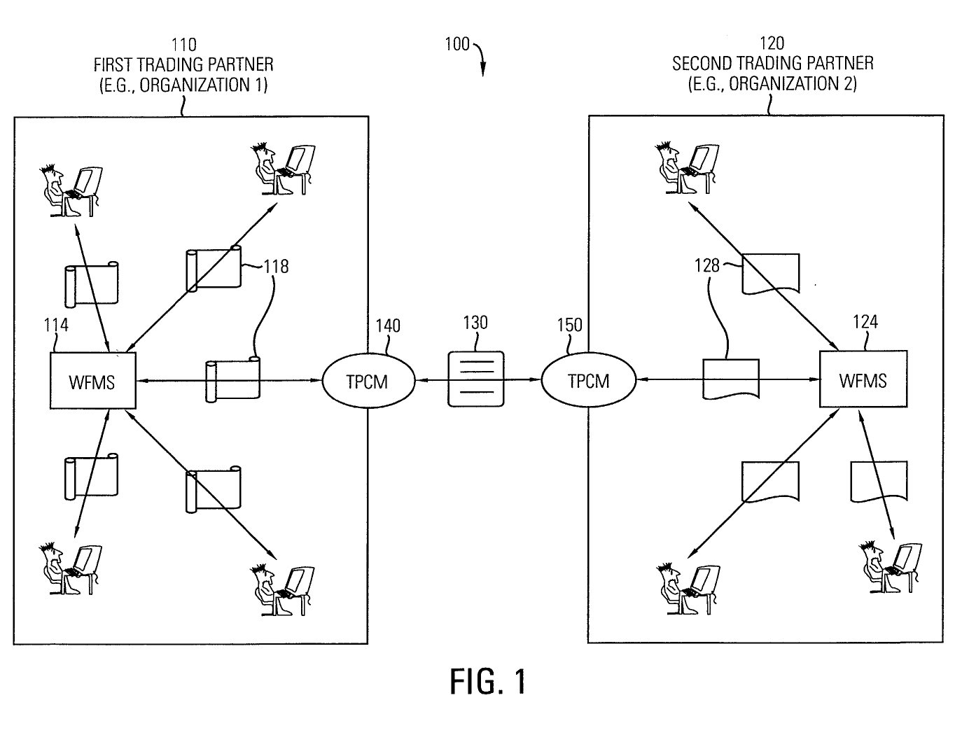

FIG. 1 is a block diagram illustrating a system 100 for supporting the integration of workflow management systems with business-to-business interaction standards according to one embodiment of the present invention. The system 100 includes a first trading partner 110 (e.g., a first organization or business) and a second trading partner 120 (e.g., a second organization or business). The first trading partner 110 includes a first workflow management system (WfMS) 114 and a plurality of internal business processes 118 for executing thereon. Similarly, the second trading partner 120 includes a second workflow management system (WfMS) 124 and a plurality of internal business processes 128 for executing thereon. It is noted that the internal business processes 128 of the second trading partner 120 may be the same as or different from (as shown) the internal business processes 114 of the first trading partner 110. In this regard, the first trading partner 110 and the second trading partner 120 interact by employing an interaction standard 130.

The first trading partner 110 includes a first trading partner conversation manager (first TPCM) 140 for executing business-to-business (B2B) services by automatically mapping internal workflow data representation into a format required by an interaction standard and vice versa. The first TPCM 140 manages conversations (i.e., sequences of interactions with a trading partner, such as a service provider). For example, the first TPCM 140 automatically converts messages having a first data representation (e.g., a representation specified by the internal business processes 118) into corresponding messages having the communication format specified by the interaction standard 130. Similarly, the trading partner conversation manager automatically converts messages having the communication format specified by the interaction standard into corresponding messages having the first data representation (e.g., a representation that is compatible with the internal business processes 118).

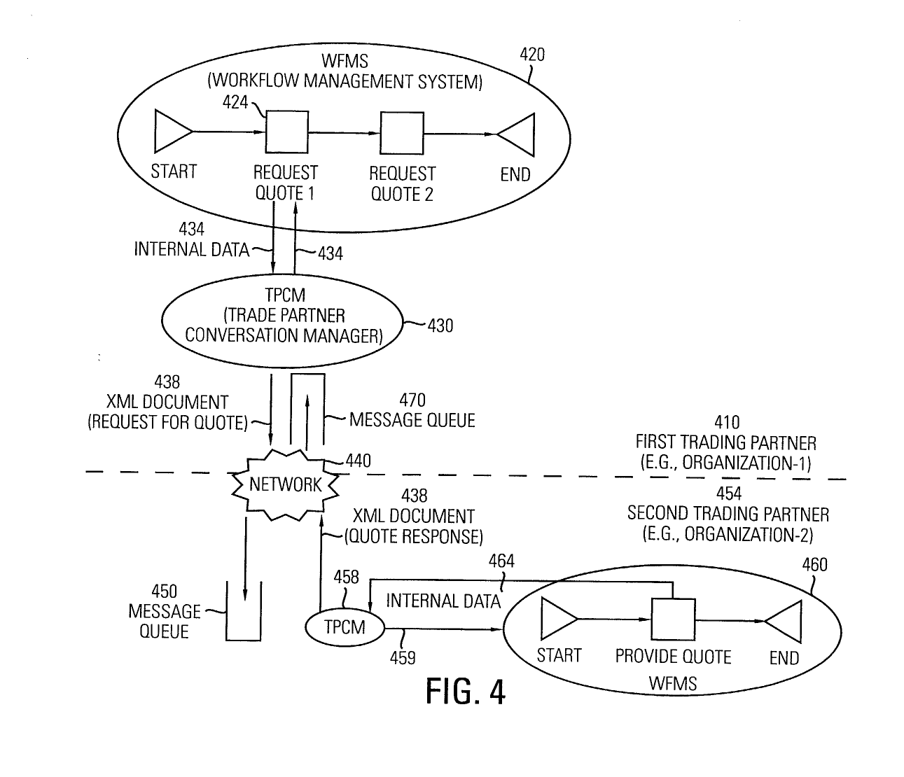

As described in greater detail hereinafter with reference to FIG. 4, the TPCM may be utilized to execute workflow activities by sending a B2B message to a trading partner and possibly waiting for a reply. The TPCM then extracts data from the reply before returning the output of the activity to the WfMS. Furthermore, the TPCM can activate a given process instance as a B2B message of a specified type is received.

Preferably, the TPCM acts as a workflow resource that can be employed by the WfMS to handle interactions with different trading partners that may use different business-to-business (B2B) interaction standards. For example, the TPCM can perform the conversion between scalar variables in workflows and the mark-up language documents (e.g., XML documents) that are used by industry standards.

One advantage of the TPCM of the present invention is that the TPCM supports changes to industry standards or even new industry standards and makes theses changes to the B2B standards transparent to workflows. In this manner, the TPCM can efficiently manage the modifications or extensions to the industry standards and at the same time leave the workflow unchanged. Another advantage of the TPCM of the present invention is that the TPCM supports the interface of workflows to different B2B standards. The TPCM also reduces the amount of manual effort and development time needed to integrate internal business processes with external interaction standards.

The second trading partner 120 includes a second trading partner conversation manager (second TPCM) 150 for mapping internal workflow data representation into a format required by an interaction standard and vice versa.

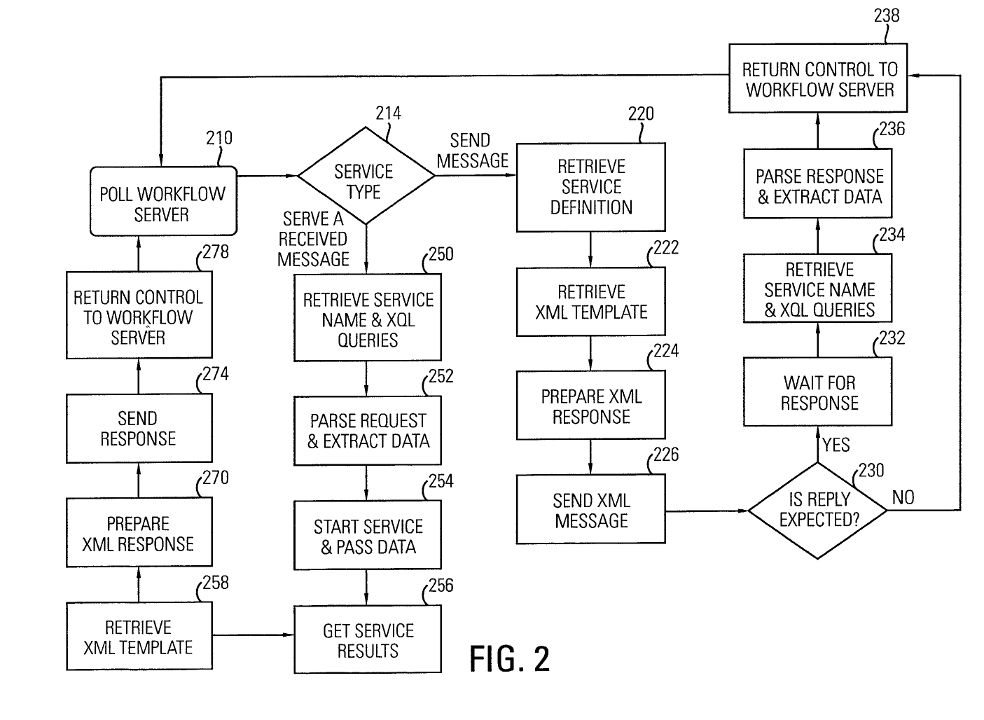

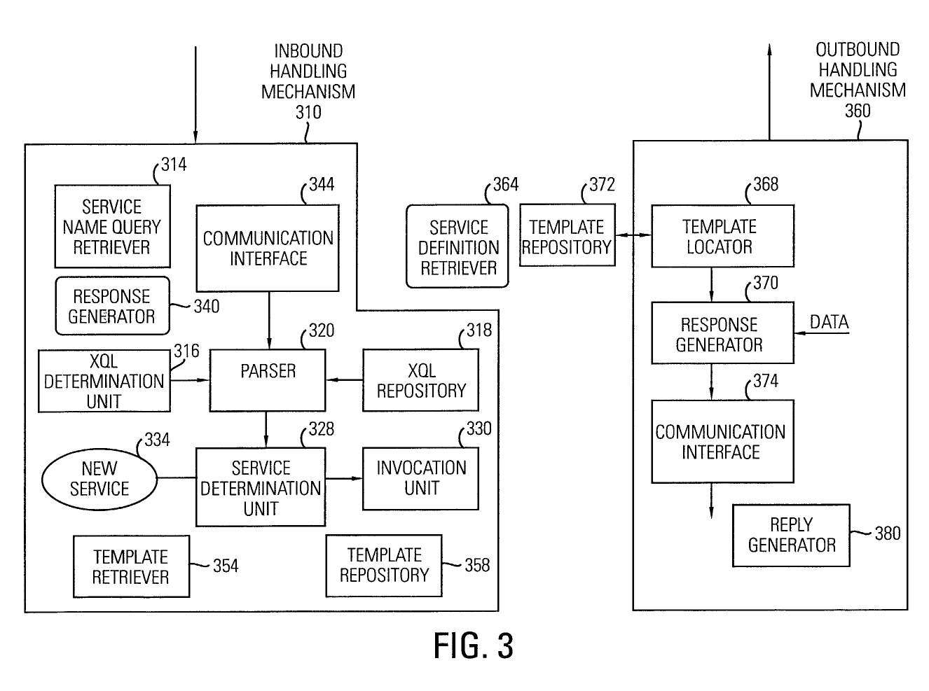

The first trading partner conversation manager (first TPCM) 140 and the second trading partner conversation manager (second TPCM) 150 are described in greater detail hereinafter with reference to FIGS. 2 and 3.

TPCM

FIG. 3 is a block diagram illustrating in greater detail the TPCM (e.g., first TPCM 140 or second TPCM 150) of the FIG. 1. The TPCM includes an inbound handling mechanism 310 for processing received messages and an outbound handing mechanism 360 for processing messages to be sent out of the current trading partner to another trading partner.

The inbound handling mechanism 310 includes a service name and query retriever 314 for retrieving a service name and XQL queries associated with a particular message from a query repository (e.g., XQL repository 318). The service name and query retriever 314 can utilize a query determination unit (e.g., XQL determination unit 316) for determining an appropriate set of queries for use with a particular received message.

The inbound handling mechanism 310 further includes a parser 320 for parsing a request and for extracting data therefrom. The message consists of a header and a body. The parser first splits those two portions of the message and then parses these two portions separately. The header is used for determining the service that is requested, and the body is used for transferring data between trade partners.

The inbound handling mechanism 310 further includes a service determination unit 328 for determining the particular service requested. The parser extracts the message type from the message header and uses a database table to map the message type into the service name that should handle the received request. The inbound handling mechanism 310 further includes service invocation unit 330 for starting a specified service (e.g., service 334) and for passing the extracted data to the service. A response generator 340 prepares a response based on the XML template that is provided by the template retriever 354. A communication interface module 344 is employed to send the response provided by the response generator 340 across a network, for example.

The inbound handling mechanism 310 also includes a template retriever 354 for retrieving from a template repository 358 an XML template that is suitable for a particular interaction standard 130.

The outbound handing mechanism 360 can include a server definition retriever 364 for retrieving a service definition and a template repository 372 for storing templates. The outbound handing mechanism 360 further includes a template locator 368 for retrieving from the template repository 372 a template (e.g., an XML template) corresponding to the interaction standard. The outbound handing mechanism 360 further includes a response generator 370 for preparing a response based on the retrieved XML template and data received from a node of a business process, for example. A communication interface module 344 is provided for communicating or sending the message to the other trading partner.

The outbound handing mechanism 360 further includes a reply generator 380. The reply generator 380 first determines if a reply is expected for this message. When a reply is not expected, the outbound handling mechanism 360 returns control to the workflow server. When a reply is expected, the reply generator 380 waits for a response from the trading partner, retrieves service name and queries, parses the response and extracts the data from the response, and then returns control to the workflow server.

FIG. 4 illustrates how the TPCM of the present invention facilitates the interaction between two trading partners. A first trading partner 410 (e.g., a first organization) includes a first business process 420 that includes a node 424 in which a first request for a quote is performed. The first trading partner 410 includes a first TPCM 430 that receives internal data 434 from the RequestQuote1 node and automatically converts the internal data 434 into a format 438 (e.g., an XML document RFQ) that complies with a previously agreed interaction standard. The XML document 438 is then sent across a network 440 and received into a message queue 450 in the second trading partner 454 (e.g., a second organization).

The second trading partner 454 includes a second TPCM 458 for receiving the message and automatically converting the message into a format 459 that is recognizable and usable by the second trading partner 454. In this example, a business process 460 for generating quotes is invoked. The internal data 464 that is generated by this business process 460 is then provided to the second TPCM 458, which in turn automatically converts the internal data 464 into a format 438 (e.g., an XML quote response) that complies with a previously agreed interaction standard. The response is then sent across the network 440 and received in a message queue 470 in the first trading partner 410. The first TPCM 430 receives the response and automatically generates data 434 in an internal format that is acceptable to the first business process 420.

Processing Steps

FIG. 2 is a flow chart illustrating the processing steps performed by the TPCM of FIG. 1 in accordance with one embodiment of the present invention. In step 210, the workflow server is polled. In decision block 214, a determination is made whether the service type is a send message or a serve message type. When the service type is a send message, steps 220 through 238 are performed. When the service type is a serve message, steps 250 through 278 are performed.

Send Message

In step 220, the TPCM retrieves a service definition. In step 222, the TPCM retrieves an XML template. In step 224, the TPCM prepares an XML response. In step 226, the TPCM sends the XML message. In decision block 230, a determination is made whether a reply is expected. When a response is not expected, control is returned to the workflow server. When a response is expected, in step 232, the step of waiting for the response is performed. In step 234, a service name and XQL queries are retrieved. In step 236, the response is parsed, and data is extracted therefrom. In step 238, control is returned to the workflow server.

Serve Message

When the service type is a receive message, in step 150, a service name and XQL queries are retrieved. In step 252, the request is parsed, and data is extracted from the request. In step 254, a service is started, and data passed to the service. In step 256, service results are obtained. In step 258, an XML template is retrieved. In step 270, a response is prepared (e.g., an XML response). IN step 274, the XML response is sent to a trading partner. In step 278, control is returned to the workflow server.

Trade Partners Conversation Manager 140

The TPCM 140 is an application that acts as a workflow resource. The TPCM 140 executes B2B services by sending a B2B message to a trade partner, possibly waiting for a reply, and extracting data from the reply before returning the service to the WfMS 114. The TPCM can also be instructed to activate a given process instance when a B2B message of a specified type is received. The content of the repository accessed by the TPCM and the operation of the TPCM are now described.

The TPCM 140 allows users to design processes without having to know details about the interaction standards. Furthermore, the TPCM automatically handles which standard to use based on the preferred standard of the trade partner. Moreover, the TPCM 140 handles the details of sending/receiving messages, waiting for responses, etc., thereby allowing the process designer to focus on designing workflow to meet the needs of the business.

TPCM Repository 144

The TPCM 140 includes a repository 144 for storing information for each B2B service. The repository 144 can, for example, include the following information items for each B2B service defined in the service library: 1) an XML template document 146, and 2) a set of XQL queries 148.

The XML template document 146 can conform to the DTD or XML schema of the outbound message type. The XML templates 146 are used by the TPCM 140 to generate outbound messages as B2B services are invoked. TABLE III illustrates an exemplary XML document template.

The XML templates 146 may include references to service input data as denoted with %% signs for customizing the message with process instance specific data. XML templates are generated from the XML DTD or schema language definitions that are provided by B2B interaction standards. Any reference to a service data item name is included between double percent symbols (e.g., %%Contact_Name%%). While preparing a B2B message, the TPCM 140 retrieves the XML template 146 from the repository, replaces service data item references with the actual value of those data items, and then submits the B2B message, which contains the XML document to the trade partner.

The set of XQL queries 148 can include, for example, one query for each output data item of the service. XQL queries 148 are used by TPCM to parse received XML documents and feed received data into the service data items. TABLE II illustrates a set of exemplary XQL queries, associated with the RFQ service, for use in parsing the document of TABLE I.

TABLE I

<?xml version=”1.0”?>
<Pip3A1QuoteRequest>

<fromRole>

<PartnerRoleDescription>

<ContactInformation>

<contactName>

<FreeFormText xml:lang=”en-US”>

%%ContactName%%

</FreeFormText>

</contactName>
<EmailAddress>

%%ContactEmail%%
</EmailAddress>
<telephoneNumber>

%%ContactTelephoneNumber%%

</telephoneNumber>

</ContactInformation>
...

</PartnerRoleDescription>

</fromRole>

</Pip3A1QuoteRequest>

TABLE II

ContactInformation/contactName/FreeFormText

ContactInformation/EmailAddress

Execution of B2B Services

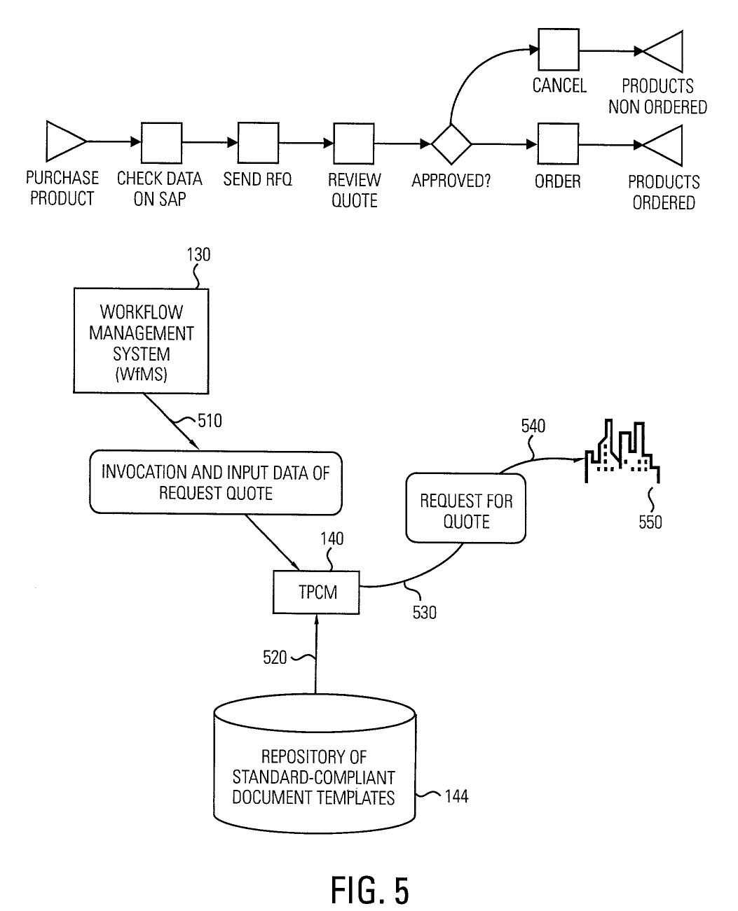

FIG. 5 illustrates the processing steps performed by the TPCM (e.g., TPCM 140) of FIG. 1 when submitting B2B messages according to one embodiment of the present invention. Depending on the operation of the WfMS 114, the TPCM 140 either periodically polls the WfMS to check if there is a B2B service to be executed or waits for the notification message of a particular event occurrence from the WfMS 114.

In step 510, the TPCM 140 retrieves the service name and input data from the WfMS. For example, when a node “Send RFQ” is scheduled by the WfMS for execution, the service “Request Quote” is invoked along with the input parameter.

In step 520, the TPCM 140 retrieves the XML template that is associated to the service from the repository 144. For example, the TPCM retrieves the document template corresponding to the B2B service “Request Quote” and to the specified protocol or a predetermined default protocol when no protocol is specified. In general, the repository 144 may have one entry per service and per protocol.

In step 530, the TPCM 140 generates an outbound message and replaces all the references to service input data items with their actual values. For example, the TPCM 140 can build the B2B outbound message by instantiating the document template (i.e., replacing the parametric parts with actual values) and by packaging the instantiated document template into a standard-compliant message with an appropriate header.

In step 540, the TPCM 140 sends the document to a trade partner 550 that is specified by B2B partner input data item. When no B2B partner is specified, the document may be sent to a predetermined default B2B partner.

If no reply is expected after a message submission, the TPCM 140 returns the completed service results to the WfMS 114. Otherwise, the TPCM 140 waits to receive a reply.

It is noted that the node “Send RFQ” is bound at process definition time to the B2B service “Request Quote” that is retrieved from the B2B service repository 144.

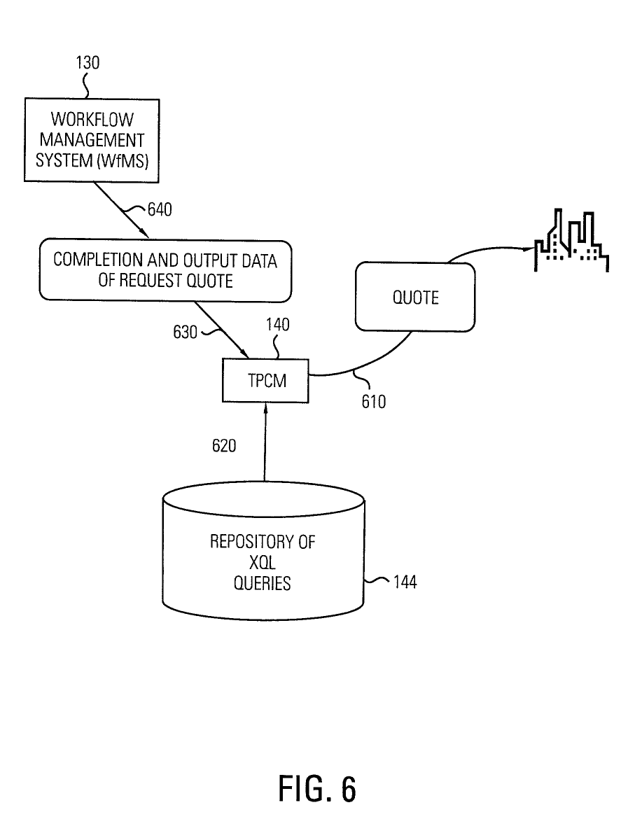

FIG. 6 illustrates the processing steps performed by the TPCM 140 of FIG. 1 upon receiving a reply according to one embodiment of the present invention. In step 610, the reply is received. For example, a partner sends the requested quote in the form of a standard compliant XML document that is encapsulated in a standard-compliant message.

In step 620, the TPCM 140 accesses the repository 144 in order to retrieve the set of XQL queries associated with the service. The TPCM 140 retrieves the XQL queries in order to use the queries to extract data from the received document. An appropriate set of queries is determined based on the type of document received and on the B2B interaction standard (e.g., a RosettNet quote document).

In step 630, for each output data item, the TPCM 140 executes the XQL queries on the received document, thereby determining the values of the attributes to be passed back to the calling workflow as service output data.

In step 640, the extracted data is made available to the data items of the B2B service. The service execution is now completed, and the output values are returned to the WfMS 114. The WfMS 114 updates the case packet of the calling workflow and then schedules the next node for execution. TABLE III illustrates a sample RFQ reply in XML format and the values assigned to the service data items.

TABLE III

<?xml version=”1.0”?>
<Pip3A1QuoteResponse>

<fromRole>

<PartnerRoleDescription>

<ContactInformation>

<contactName>

<FreeFormText xml:lang=”en-US”>

Mary Brown

</FreeFormText>

</contactName>
<EmailAddress>

amy@mycompany.com

</EmailAddress>
<telephoneNumber>

1-323-5551212

</telephoneNumber>

</ContactInformation>
...

</PartnerRoleDescription>

</fromRole>

</Pip3A1QuoteResponse>

Message-Driven Process Instantiation

The TPCM 140 can be instructed to activate a process instance in order to process a request coming from a business partner. When the TPCM 140 receives a message that is not a reply to a previous request, the TPCM 140 checks if there is a B2B start service associated to the messages of that type. When there is a B2B start service associated to the messages of that type, the TPCM 140 retrieves the XQL queries associated to the service data items, executes them against the inbound message in order to extract the data to be inserted into the input data items of the service, and then starts the process by executing the service associated with the start node of that process.

TPCM Implementation

After sending a request to a trade partner, the XML document response is received by a daemon process that listens to a specific port for the incoming messages. The data is extracted from the document and mapped into the service data items. The TPCM 140 needs to know which service instance of which process instance had initiated the request, so that the response can be delivered to that service instance. For this purpose, when submitting a message across the organizational boundaries, the TPCM 140 keeps a record of the service and process instance that is relevant to the message.

Preferably, the TPCM 140 tracks the following information from the service instance that wants to submit an interaction message to an external organization: 1) the name of the trade partner to which the message is going to be sent, and 2) the process instance and service identifiers for the B2B service that submitted the message. The TPCM 140 also manages a table that maps a trade partner name into the IP address and port number of a trade partner.

Furthermore, the TPCM 140 automatically generates a document identification number for uniquely identifying the document that is being submitted and its response. The document identifier is then piggybacked in the response message. The TPCM 140 records the document, process instance, and service identifiers in the repository 144 so that the TPCM 140 can locate the process instance and service when the response with the same document identifier arrives.

Support for Multiple B2B Standards

The integration method and system of the present invention has been described with reference to the HPPM WfMS and RosettaNet PIPs. However, it is to be appreciated that the teachings of the present invention can be applied to integrate other interaction standards with other workflow management systems. An important step in the integration of interaction standards to a workflow management system of according to the present invention is the generation of templates in three detail levels: 1) process, 2) service, and 3) XML document formats.

For example, templates for CBL, EDI, and other B2B interaction standards may be generated from the XMI descriptions of the message flow and contents in accordance with the teachings of the present invention as described previously. Once the templates are stored in the template library, the users can access the needed templates and plug the templates into the process flow diagrams.

The tools and mechanisms of the present invention have been described in the context of integrating HPPM processes with RosettaNet PIPs as an example. It is to be appreciated that the tools, mechanisms, and teachings of the present invention can be extended to support other WfMSs and other B2B interaction standards.

In the foregoing specification, the invention has been described with reference to specific embodiments thereof. It will, however, be evident that various modifications and changes may be made thereto without departing from the broader scope of the invention. The specification and drawings are, accordingly, to be regarded in an illustrative rather than a restrictive sense.

What is claimed is:

1. A method for enabling at least one internal business process that uses a first data representation and that includes at least one activity that involves a trading partner to communicate with the trading partner through an interaction standard comprising the steps of:
a) receiving a message having the first data representation from the internal business process; and
b) automatically converting the message having the first data representation into a corresponding message having the communication format specified by the interaction standard.

2. The method of claim 1 further comprising the step of:
c) receiving a message in the communication format from the trading partner; and
d) automatically converting the received message having the communication format specified by the interaction standard into a corresponding message having the first data representation.

3. The method of claim 1 wherein the interaction standard is one of a peer-to-peer (P2P) standard and a business-to-business (B2B) standard.

4. The method of claim 2 wherein the interaction standard is one of RosettaNet and the Common Business Library (CBL).

5. The method of claim 1 wherein the internal business process includes at least one workflow.

6. The method of claim 1 wherein the step of automatically converting the message having the first data representation into a corresponding message having the communication format specified by the interaction standard
retrieving a service definition;
retrieving a mark-up language document template; and
preparing a mark-up language message that is based on the mark-up language document template.

7. The method of claim 2 wherein the step of automatically converting the received message having the communication format specified by the interaction standard into a corresponding message having the first data representation includes
retrieving at least one XQL query; and
executing the XQL query to extract the data from the reply.

8. A system comprising:
a) an internal business process that includes a first data representation;
b) an interaction standard for specifying a communication format for communication between the internal business process and at least one trading partner; and
c) a trading partner conversation manager for managing conversation between the internal business process and the trading partner.

9. The system of claim 8 wherein the trading partner conversation manager automatically converts messages having the first data representation into corresponding messages having the communication format specified by the interaction standard.

10. The system of claim 8 wherein the trading partner conversation manager automatically converts messages having the communication format specified by the interaction standard into corresponding messages having the first data representation.

11. The system of claim 8 wherein the trading partner conversation manager automatically maps a first message with the first data representation into a corresponding first message in the communication format, and automatically maps a second message in the communication format into a corresponding second message in the first data representation.

12. The system of claim 8 wherein the interaction standard is one of a peer-to-peer (P2P) standard and a business-to-business (B2B) standard.

13. The system of claim 8 wherein the interaction standard is one of RosettaNet and the Common Business Library (CBL).

14. The system of claim 8 wherein the internal business process includes at least one workflow.

15. A method for managing conversation between a first enterprise and a second enterprise in comprising the steps of:
a) determining whether communication with an external trading partner is needed;
when communication with an external trading partner is needed performing the following:
b) determining whether the communication is inbound or outbound;
c) when the communication is inbound, performing inbound communication processing; and
d) when the communication is outbound, performing outbound communication processing.

16. The method of claim 15 wherein the step of determining whether communication with an external trading partner is needed includes the step of
polling a workflow server.

17. The method of claim 15 wherein the step of determining whether the communication is inbound or outbound includes the step of
determining whether a service type is a send message or a receive message.

18. The method of claim 15 wherein the step of performing inbound communication processing includes the steps of
retrieving a service name and XQL queries;
parsing the request and extracting data;
starting the service and passing data;
obtaining service results;
retrieving an XML template;
preparing an XML response;
sending the XML message; and
returning control to the workflow server.

19. The method of claim 15 wherein the step of performing outbound communication processing includes the steps of
retrieving a service definition;
retrieving an XML template;
preparing an XML response; and
sending the XML message.

20. The method of claim 19 wherein the step of performing outbound communication processing further includes the steps of
determining if a response is expected;
when a response is not expected, returning control to the workflow server;
when a response is expected, waiting for the response, retrieving service name and XQL queries, parsing the response and extracting data, and returning control to the workflow server.
